(19) United States
(12) Patent Application Publication
(10) Pub. No.: US 2014/0144590 A1
(43) Pub. Date: May 29, 2014

(54) ADHESIVE STRUCTURE, SURFACE TREATING AGENT, AND METHOD OF SEPARATING THE SAME

(71) Applicant: HON HAI PRECISION INDUSTRY CO., LTD., New Taipei (TW)

(72) Inventors: JHIH-KUEI GE, New Taipei (TW); CHIH-PEN LIN, New Taipei (TW); MING-JEN CHANG, New Taipei (TW)

(73) Assignee: HON HAI PRECISION INDUSTRY CO., LTD., New Taipei (TW)

(21) Appl. No.: 14/080,969

(22) Filed: Nov. 15, 2013

(30) Foreign Application Priority Data
Nov. 23, 2012 (TW) 101144075

(51) Int. Cl. B32B 7/06; B32B 43/00

(52) U.S. Cl. CPC B32B 7/06; B32B 43/006
USPC 156/701; 428/327; 252/62.54

(57) ABSTRACT

An adhering structure is disclosed. The adhering structure includes an adhering member, an adhesive layer, and a surface treatment layer sandwiched between the adhering member and the adhesive. The surface treatment layer includes a plurality of magnetic disabling particles. Each of the plurality of magnetic disabling particles has a core-shell structure, and includes a magnetic shell and a core capsulated in the magnetic shell. The core decreases an adhesive strength of the adhesive layer.

### BACKGROUND

1. Technical Field

The present disclosure relates to adhesive structures, and particularly to an adhesive structure which has a high adhesive strength and can be easily separated.

2. Description of the Related Art

Adhesive is usually used for adhering two workpieces together. Often, a high adhesive strength is needed for adhering the two workpieces strongly. However, if the two workpieces adhered together need rework, the two workpieces must be separated from each other. Thus, the adhesive should have both a high adhesive strength and an easy peeling ability.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows a cross-sectional view of a first embodiment of an adhesive structure.

FIG. 2 illustrates a flowchart of one embodiment of method for separating an adhesive structure.

### DETAILED DESCRIPTION

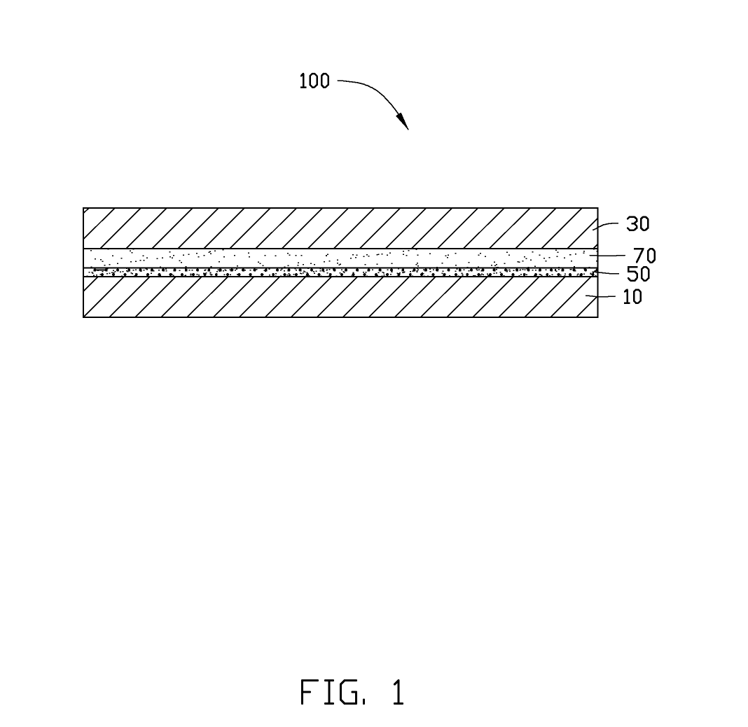

FIG. 1 shows a first embodiment of an adhesive structure 100. The adhesive structure 100 includes a first adhering member 10, a second adhering member 30, a surface treatment layer 50, and an adhesive layer 70 sandwiched between the surface treatment layer 50 and the second adhering member 30. In one embodiment, the first adhering member 10 and the second adhering member 30 are metallic plates. In other embodiments, the structure and material of the first adhering member 10 and the second adhering member 30 can be changed as needed. For example, the first adhering member 10 is a glass substrate, and the second adhering member 30 is a plastic housing. The adhesive layer 70 is formed by coating adhesive on the surface treatment layer 50, so that the first adhering member 10 and the second adhering member 30 can be adhered together.

The surface treatment layer 50 is formed by coating a surface treatment agent on the first adhering member 10, for enhancing an adhering strength between the first adhering member 10 and the adhesive layer 70. The surface treatment agent contains 5-10 wt % resin, 0.1-1.0 wt % magnetic disabling particles, and the rest being solvent. The resin is dissolved in the solvent. The resin can be acrylic resin, such as polymethyl methacrylate (PMMA). In other embodiments, the resin can be other types of resin, as long as the resin is capable of enhancing the adhering strength. The magnetic disabling particles are dispersed in the solvent. Each magnetic disabling particle has a core-shell structure, and includes a magnetic shell and a core capsulated in the magnetic shell. The magnetic shell is magnetic, and can be made of materials such as ferroferric oxide (Fe₃O₄), ferric oxide (Fe₂O₃), ferromanganese oxide (MnFe₂O₄), ferrocobalt oxide (CoFe₂O₄), ferronickel (NiFe₂O₄), and other magnetic materials. The core is capable of decreasing an adhesive strength of the adhesive layer 70, and can be silicone oil, wax, or any other material so long as the core can decrease the adhesive strength of the adhesive layer 70. The solvent is one or more organic solvents such as isoparaffin, toluene, ethyl acetate, acetone, and butanone, as long as the solvent is capable of dissolving the resin. The solvent can also be omitted with the magnetic disabling particles directly dispersed in the resin, and a weight ratio of the resin to the magnetic particles in a range from 5 to 100.

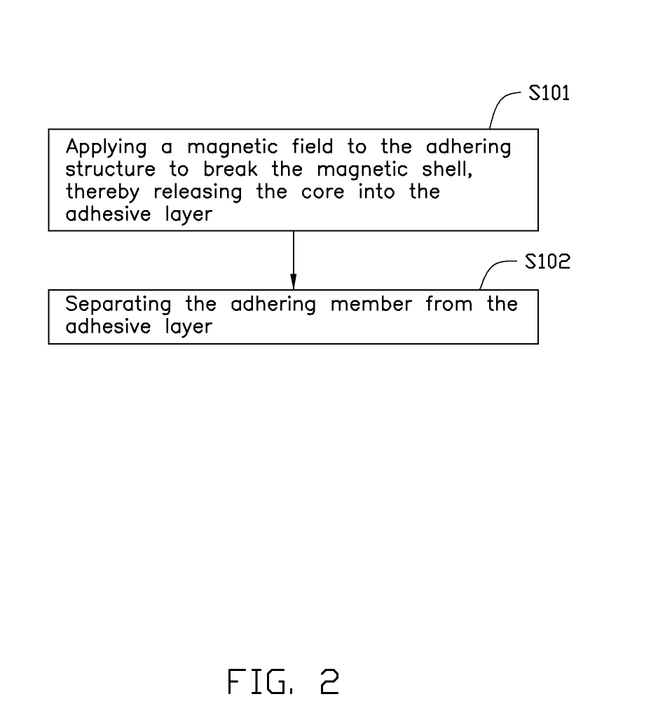

Referring also to FIG. 2, one embodiment of a method for separating the adhering structure 100 is illustrated as follows.

In step S101, the adhering structure 100 is applied in a magnetic field to break the magnetic shell, thereby releasing the core into the surface treatment layer 50.

In step S102, the adhering structure 100 is separated from each other, and the adhesive layer 70 is peeled of from the second adhering member 30.

The second adhering member 30 can be omitted, and the adhering structure 100 includes only the first adhering member 10, the surface treatment layer 50, and the adhesive layer 70.

Because the magnetic disabling particles are dispersed in the surface treatment layer 50, when the adhering structure 100 is applied in a magnetic field, the released core decreases the adhering strength of the adhesive layer 70. Thus, the first adhering member 10 can easily separate from the second adhering member 30. Heating and light radiation, which could affect the properties of the first adhering member 10 and the second adhering member 30, are not used.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An adhering structure comprising an adhering member, an adhesive layer, and a surface treatment layer sandwiched between the adhering member and the adhesive layer, wherein the surface treatment layer comprises a plurality of magnetic disabling particles, each of the plurality of magnetic disabling particles has a core-shell structure and comprises a magnetic shell and a core capsulated in the magnetic shell, and the core decreases an adhesive strength of the adhesive layer.

2. The adhering structure of claim 1, wherein the magnetic shell is made of one or more materials selected from the group consisting of ferroferric oxide (Fe₃O₄), ferric oxide (Fe₂O₃), ferromanganese oxide (MnFe₂O₄), ferrocobalt oxide (CoFe₂O₄), and ferronickel (NiFe₂O₄).

3. The adhering structure of claim 1, wherein the core is silicone oil or wax.

4. The adhering structure of claim 1, wherein the surface treatment layer further comprises a resin, and the plurality of magnetic disabling particles are dispersed in the resin.

5. The adhering structure of claim 4, wherein a weight ratio of the resin to the plurality of magnetic disabling particles is in a range from 5 to 100.

6. A surface treatment agent comprising a resin and a plurality of magnetic disabling particles dispersed in the resin, wherein each of the plurality of magnetic disabling particles has a core-shell structure and comprises a magnetic shell and a core capsulated in the magnetic shell, and the core decreases an adhesive strength of an adhesive.

7. The surface treatment agent of claim 6, wherein a weight ratio of the resin to the plurality of magnetic disabling particles is in a range from 5 to 100.

8. The surface treatment agent of claim 6, wherein the magnetic shell is made of one or more materials selected from the group consisting of ferroferric oxide (Fe₃O₄), ferric oxide (Fe₂O₃), ferromanganese oxide (MnFe₂O₄), ferrocobalt oxide (CoFe₂O₄), and ferronickel (NiFe₂O₄).

9. The surface treatment agent of claim 6, wherein the core is silicone oil or wax.

10. A method for separating an adhering structure, the adhering structure comprising an adhering member, an adhesive layer, and a surface treatment layer sandwiched between the adhering member and the adhesive layer, wherein the surface treatment layer comprises a plurality of magnetic disabling particles, each of the plurality of magnetic disabling particles has a core-shell structure and comprises a magnetic shell and a core capsulated in the magnetic shell, and the core decreases an adhesive strength of the adhesive layer, the method comprising:
applying a magnetic field to the adhering structure to break the magnetic shell, thereby releasing the core onto the adhesive layer; and
separating the adhering member from the adhesive layer.
